(19) United States
(12) Patent Application Publication
(10) Pub. No.: US 2021/0189674 A1
(43) Pub. Date: Jun. 24, 2021

(54) FACILITY FOR CONTROLLING FLOODING RELATING TO RISES IN THE LEVEL OF A WATERWAY

(71) Applicant: Hydroplus, Rueil-Malmaison (FR)

(72) Inventors: Julien RAYSSIGUIER, Rueil-Malmaison (FR); Franck Del Rey, Rueil-Malmaison (FR)

(21) Appl. No.: 17/252,467

(22) PCT Filed: Jun. 14, 2019
(86) PCT No.: PCT/EP2019/065654

§ 371 Date: Dec. 15, 2020

(30) Foreign Application Priority Data
Jun. 15, 2018 (FR) 1855282

(51) Int. Cl. E02B 3/02; E02B 7/40

(52) U.S. Cl. CPC E02B 3/02; E02B 7/40

(57) ABSTRACT

Installation for combating flooding associated with spates of a waterway, including a mobile barrage, an acceleration station designed to pump water through or under the mobile barrage, from upstream of the mobile barrage to downstream when this barrage is in the active configuration, so as to increase the gradient of the stream upstream of the barrage and increase the flow rate.

### TECHNICAL FIELD

The present invention relates to methods and installations for combating flooding associated with spates of a waterway.

### PRIOR ART

The rise in the level of waterways, particularly in spring and in fall or after lengthy periods of rain, may cause spates and flooding which cause significant material damage.

In order to prevent a waterway from running in spate, it is known practice to employ methods such as:
building embankments around the waterway; however, this solution may prove ineffective in the event of heavy and sustained periods of rain; in addition, this solution becomes ineffective as soon as the water level brought about by the spate becomes higher than the top of the embankment; there is then a risk of these constructions bursting and potentially causing greater damage than the spate;
improving the drainage of the waterway by dredging and widening; this solution might be effective only over long distances and what is more, widening may be impossible to achieve in an urban zone;
reducing the flow rate of the waterway by storing water in reservoirs; the viability of this solution depends on the storage capacity of these reservoirs; thus, in the event of heavy rain arriving late in the season, these reservoirs may already be full; it is therefore necessary to build large reservoirs, which requires the creation of substantial and expensive installations.

Application FR 2560244A1 describes a method and an installation able to limit spates of a waterway. This method consists in pumping, in the event of spate, part of the flow rate of the waterway into a bypass that in normal times is dry and that can be used for other purposes, such as a road or rail tunnel for example. This method entails the creation of expensive infrastructures.

Application EP 2888413A1 describes a method for combating flooding caused by tsunami, in which method the water is pumped for storage in reservoirs.

### SUMMARY OF THE INVENTION

There is still a need to improve flood combating systems still further so as to provide an installation of which the cost is acceptable in comparison with the value of the damage caused by the spate, and which can easily be installed on a navigable waterway without permanently impeding the navigability, and with a limited impact on the environment.

The invention achieves this objective using an installation for combating flooding associated with spates of a waterway, comprising:
a mobile barrage,
an acceleration station, preferably arranged below the mobile barrage, designed to pump water through or under the mobile barrage, from upstream of the mobile barrage to downstream when this barrage is in the active configuration, so as to increase the gradient of the stream upstream of the barrage and increase the flow rate.

The flow rate of a waterway corresponds to the mean velocity V of the water over a given cross section S, divided by the area of the cross section. As a first approach, the mean velocity V is connected to the flow gradient i by the following relationship:

V=K\sqrt{Ri},

where K is a constant and R corresponds to the ratio of the cross section to the perimeter of this cross section.

It may be seen that it is possible to increase the flow gradient i by accelerating the velocity of the stream V. This acceleration is obtained using the installation according to the invention. That makes it possible to lower the water line upstream of the mobile barrage and thus minimize the impact of the spate upstream.

The mobility of the barrage of the installation according to the invention makes it possible to combat flooding without excessively impacting on the flow of the waterway when there is no need to combat the spate; in particular, this waterway may remain navigable; the invention also makes it possible to minimize the impact on pisciculture and sediment.

The acceleration station may comprise at least one pumping unit, notably of the bulb type. In the event of spate, the unit may operate in pumping mode and therefore pump water from upstream of the barrage to downstream. The unit may have a power greater than 5 MW, notably ranging from 5 MW to 15 MW and for example of the order of 10 MW, a mean flow rate greater than 200 m³/s, notably comprised between 200 and 400 m³/s, for example of the order of 260 m³/s, and a diameter greater than 3 m, notably comprised between 3 and 8 m, for example of the order of 5 m.

The acceleration station may comprise at least one screen rake at the inlet to the acceleration station, before the water intake. The screen rake is able to protect the installation against the unwanted inlet of large floating objects and/or of bulky particles that could adversely affect the efficiency of the pumping. It preferably screens out particles of dimensions greater than 50 mm.

The acceleration station may be embedded in the bed of the waterway. Thus, it disturbs the flow of the water little if at all, and its impact on the environment is limited, because there has been no digging-out of the banks to accommodate the installation.

The acceleration station may rest on foundations anchored in the bed of the waterway and the mobile barrage may be supported by the foundations of the acceleration station and/or by this station or in some other way. Thus, the foundations can be used both to support the acceleration station and the mobile barrage. By way of example, the foundations may comprise a general raft foundation resting on piles, notably made of concrete.

The acceleration station may have a pumping capacity of at least 105% of the capacity of the non-equipped waterway.

The acceleration station may have a pumping capacity of at least 200 m³/s, or better, a pumping capacity of at least 250 m³/s.

The water intake of the acceleration station may be at least 0.5 m from the water level upstream, for example less than 3 m from the water level upstream. This water intake admits water at a depth that allows it to remain submerged despite the drop in level brought about by the pumping.

The installation may advantageously comprise a means for detecting the level of the waterway upstream of the mobile barrage and the pumping power may be adjusted in real time according to at least the detected level.

The mobile barrage may be permanently present on site and adopt either a retracted configuration or a barrage-forming active configuration. In the retracted configuration, the barrage is able not to impede the navigability of the waterway.

The mobile barrage may comprise at least one of the following elements:
flap gates which are lowered in order to allow the water to pass,
flashboards, sorts of rectangular panels which, attached via one side to the acceleration station, can be raised and wedged in position by a mechanical system such as a rack, for example, or
any other suitable device.

The mobile barrage may be transportable so that it can be installed at the moment at which the acceleration station needs to be used, and removed thereafter. In that case, the mobile barrage comprises, for example, at least one inflatable tube.

The installation according to the invention may comprise structures submerged or embedded in the bed of the waterway, such as foundations for example, that do not form obstacles to navigation when the acceleration station is not being used, and which are able to hold one or more submerged pumping units of the acceleration station in place at the moment at which the acceleration station needs to be used. In that case, the acceleration station may be designed to be transportable by river.

The installation may comprise at least one lock wall configured to allow the mobile barrage and/or the acceleration station to be anchored to it. The lock wall or walls may be made of concrete or in any other form, for example may comprise metal sheet piles.

The lock wall or walls may be secured to a raft or may be independent.

A further subject of the invention is a method for combating a risk of flooding associated with spates of a waterway, notably by using an installation according to the invention as defined hereinabove, wherein a mobile barrage is fitted across the waterway and water is pumped using an acceleration station at a flow rate high enough to lower the level of the water line upstream of the mobile barrage.

The pumping may be through or under the mobile barrage, which means to say that, when viewed from above, the water that is pumped passes under the mobile barrage and/or through at least one opening therein provided for that purpose.

The acceleration station may be permanently present on site, notably being fully submerged and/or embedded in the bed of the waterway. The pumping station is preferably fully submerged.

The acceleration station may alternatively be brought onto site at the moment at which it is to be used, and may comprise one or more pumps which are submerged and held in place by foundations that already exist on the site and/or by at least one lock wall. This makes installation maintenance easier and makes it possible not to impede the navigability of the waterway when the installation does not need to be used.

The mobile barrage may be permanently present on site, notably being fully submerged when inactive, in a configuration in which it impedes the flow of the water little if at all. Thus it does not create any appreciable reduction in the cross section of the waterway when in the inactive state. The mobile barrage may notably be submerged at a depth of at least 0.5 m, for example at a depth of at least 3 m, when not in use, so as not to impede river traffic at the surface.

The mobile barrage may alternatively be brought onto site at the moment at which it is to be used, for example at the same time as the acceleration station, this transportation being performed for example by river.

The mobile barrage may therefore be anchored to at least one preexisting lock wall or to some other preexisting anchoring structure. The mobile barrage may also be weighted down and/or anchored to the bottom of the waterway. The pumping by the acceleration station may allow the water line to be lowered by at least 0.5 m, better by at least 1 m, better still, by at least 3 m, in comparison with the initial level prior to pumping. The value chosen may depend on the flow rate, the topography of the waterway, and the pumping capacity installed. It may be greater than 3 m.

It is advantageous to detect the level of the waterway upstream of the mobile barrage and to adjust the pumping power in real time according to at least the detected level.

### BRIEF DESCRIPTION OF THE FIGURES

The invention may be better understood from reading the following detailed description of some nonlimiting exemplary embodiments thereof and from studying the attached drawing, in which:

FIG. 1 is a schematic view in longitudinal section of an installation for combating flooding according to the invention,

FIG. 2 is an example of a pumping unit according to the invention,

FIG. 3 is a view from above of a variant of an installation for combating flooding, and

FIGS. 4A, 4B, 4C illustrate, as viewed from above, the installing of the installation of FIG. 3.

### DETAILED DESCRIPTION OF THE INVENTION

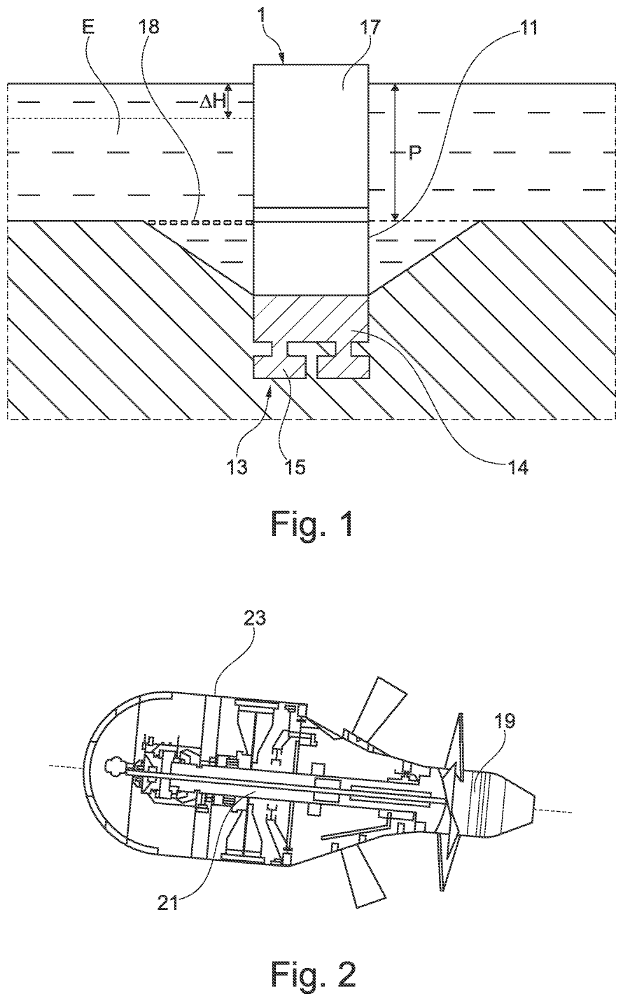

FIG. 1 depicts an example of an installation 1 for combating flooding according to the invention, with which a waterway E is equipped.

This installation 1 comprises an acceleration station 11 which is buried in the bed of the waterway and rests, for example, on concrete foundations 13. Thus, the acceleration station causes little or no disturbance to the flow of the water outside of the phases in which it is brought into service. The installation 1 also comprises a mobile barrage 17. The depth p by which the acceleration station 11 is submerged is preferably chosen to allow the waterway to remain navigable in the absence of the mobile barrage 17 or when the latter is inactive and the installation 1 is not in use. For example, the submersion depth p is at least 3 m below the free surface of the waterway.

The acceleration station 11 may be held in place in various ways and, for example, as illustrated, using foundations 13.

The acceleration station 11 comprises at least one pumping unit which allows, when the installation is in operation, the water upstream of the barrage 17 to be pumped downstream, in order to lower the upstream water level by a height H.

The acceleration station 11 may comprise any pumping unit suited to the desired flow rate.

Such a unit comprises a propeller-type turbine 19 and a motor 21, installed inside a bulb-shaped watertight casing 23, as illustrated in FIG. 2.

A screen rake 18 may be positioned in front of the water intake to protect the installation against the unwanted ingestion of large floating objects and/or of bulky particles that could detract from the efficiency of the pumping or turbine action.

The mobile barrage 17 may be a permanent presence on site, and designed to adopt either an inactive configuration that does not excessively impede the navigability of the waterway or the flow of the water, or may be designed to adopt an active configuration forming a barrage against flow, as illustrated in FIG. 1.

The mobile barrage 17 may comprise at least one barrage element that can be moved between two positions, one retracted and the other deployed. In the retracted configuration, the mobile barrage is completely submerged at a sufficient depth so as not to impede the navigability of the waterway and preferably not to impede the water flow excessively.

The mobile barrage is, for example, of the “flapgate barrage” type, comprising shutters known as “flapgates” which pivot at their base and can be raised to act as an obstacle to the flow.

FIG. 1 depicts the barrage 17 schematically because the invention is not restricted to one particular type of mobile barrage. The width of the mobile barrage 17 may range from 100 m to 400 m or more, for example being of the order of 130 m. In the event of a confirmed or potential spate, the barrage 17 is brought into the active position and acts as an obstacle to the circulation of the water. The acceleration station 11 is switched on to pump water from upstream to downstream at a flow rate higher than that of the waterway prior to the installation of the barrage and the switching-on of the pumping facility. For that purpose, the acceleration station 11 may notably have a pumping capacity of at least 105% of the capacity of the non-equipped waterway. That leads to a drop AH in level of the waterway upstream, making it possible to increase the gradient and accelerate the waterway upstream, thus reducing the risk of spate or limiting the impact thereof.

By way of example, given for a simplified configuration of waterway, if i is the flow gradient upstream and S is the cross section of the flow, given that the product S³i varies only little, doubling the gradient i allows S³ to be reduced by a factor of 2, the cross section S to be reduced by 20%, and the water level to be lowered by at least 1 m, making it possible to avoid flooding or to minimize the impact thereof.

Where appropriate, operation of the acceleration station 11 is slaved to the drop in level ΔH measured at the barrage 17. A setpoint value ΔH₀ or any other associated parameter, can be input automatically or by an operator and the pumping power can be adapted in order to maintain the drop in level at the setpoint value.

This operation can be performed on site using an automatic controller, or remotely, the control data for the installation 1 being transmitted from a control station by any means, wired or otherwise.

The drop in level ΔH₀ is chosen for example to be between 0.5 and 3 m.

Once the risk of spate has been removed, the mobile barrage 17 is deactivated, and in the event where it comprises flapgates, these are retracted. The acceleration station 11 is switched off

In the example of FIG. 1, the acceleration station 11 is a permanent presence on site, being at least partially, and better still fully, submerged and embedded in the bed of the waterway. As a variant, it is brought onto site in the event of a risk of spate, and submerged at that point. That means that the flow of water is not disturbed in its absence, without the need to bury it.

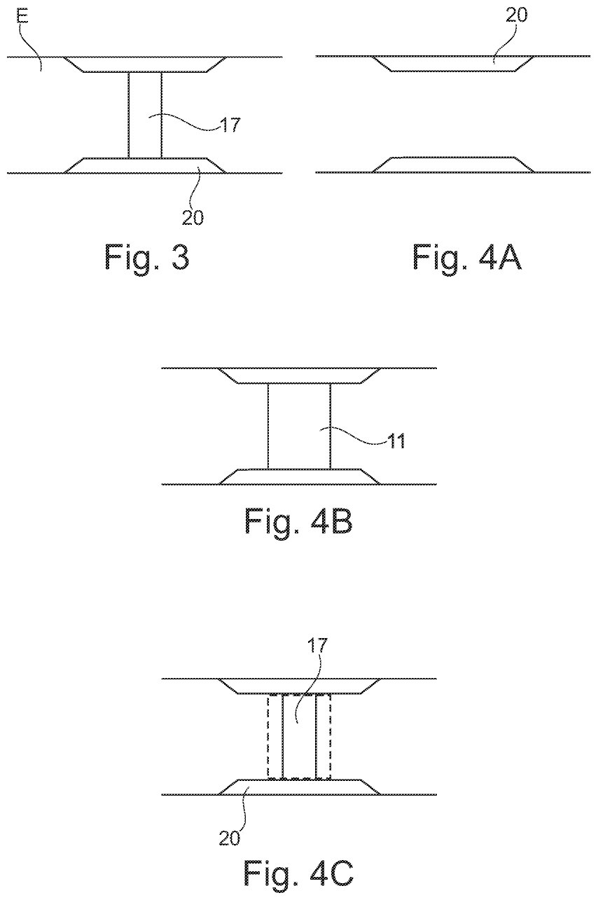

In that case, it can be anchored to preexisting foundations, present for example on the bottom of the waterway. As an alternative or in addition, it is anchored to at least one lock wall, as illustrated in FIG. 3.

This figure depicts two lock walls 20 made on the banks of the waterway. These lock walls 20 do not excessively impede the navigability of the waterway, as illustrated in FIG. 4A. These walls are produced for example using conventional civil engineering techniques from concrete or, as an alternative, using a metallic structure or a structure made from other materials.

The lock walls 20 may be independent or connected by a raft.

In the event of a risk of spate, the acceleration station 11 is brought into position by river and temporarily sunk, as illustrated in FIG. 4B, at the desired point. The lock walls 20 and the raft serve to anchor the acceleration station 11 in order to hold it in place.

The mobile barrage 17 is brought into position by river between the lock walls 20 and positioned preferably above the acceleration station 11, being for example anchored to the lock walls 20, as illustrated in FIG. 4C.

The operation of the installation is then similar to that described hereinabove.

Once the risk of spate has been removed, the barrage and the acceleration station can be removed by river and stored ready for a subsequent use.

Of course, the invention is not restricted to the examples which have just been described. In particular, the installation according to the invention can be used in combination with other techniques for combating flooding, notably the deepening of the bed and/or the storage of water in reservoirs.

The mobile barrage may notably be produced in some other way; for example, it may comprise inflatable tubes held in position by a membrane.

Where appropriate, the mobile barrage and the acceleration station constitute a one-piece assembly which is brought onto site, for example being towed by river, then submerged at the desired location.

1. An installation- for combating flooding associated with spates of a waterway, comprising:
a mobile barrage,
an acceleration station designed to pump water through or under the mobile barrage, from upstream of the mobile barrage to downstream when this barrage is in the active configuration, so as to increase the gradient of the stream upstream of the barrage and increase the flow rate.

2. The installation as claimed in claim 1, the acceleration station comprising at least one pumping unit.

3. The installation as claimed in claim 1, the acceleration station comprising at least one screen rake at the inlet to the acceleration station (11).

4. The installation as claimed in claim 1, the acceleration station being embedded in the bed of the waterway and/or located under the mobile barrage.

5. The installation as claimed in claim 1, the acceleration station resting on the foundations anchored in the bed of the waterway and the mobile barrage being supported by the foundations of the acceleration station.

6. The installation as claimed in claim 1, the acceleration station having a pumping capacity of at least 105% of the capacity of the non-equipped waterway.

7. The installation as claimed in claim 1, the water intake of the acceleration station being at least at 0.5 m from the water level upstream.

8. The installation as claimed in claim 1, comprising a means for detecting the level of the waterway upstream of the mobile barrage and the pumping power being adjusted in real time according to at least the detected level.

9. The installation as claimed in claim 1, the mobile barrage being permanently present on site and able to adopt a retracted configuration and a barrage-forming active configuration.

10. The installation as claimed in claim 9, the mobile barrage having flap gates.

11. The installation as claimed in claim 1, the mobile barrage being transportable so that it can be installed at the moment at which the acceleration station needs to be used.

12. The installation as claimed in claim 11, comprising submerged foundations that do not form obstacles to navigation when the acceleration station is not being used, and which are able to hold one or more submerged pumps in place at the moment at which the acceleration station needs to be used.

13. The installation as claimed in claim 1, comprising at least one lock configured to allow the mobile barrage and/or the acceleration station to be anchored to it.

14. A method for combating a risk of flooding associated with spates of a waterway, wherein a mobile barrage is fitted across the waterway and water is pumped through or under the mobile barrage at a flow rate high enough to lower the level of the water line upstream of the mobile barrage.

15. The method as claimed in claim 14, the water being pumped using an acceleration station permanently present on site.

16. The method as claimed in claim 14, the mobile barrage being permanently present on site.

17. The method as claimed in claim 16, the mobile barrage being submerged at a depth of at least 0.5 m when not in use.

18. The method as claimed in claim 14, the water being pumped using an acceleration station that is brought onto site at the time of its use, and that comprises one or more pumps that are submerged and held in place by foundations that already exist on the site.

19. The method as claimed in claim 14, the mobile barrage being brought onto site at the time of its use.

20. The method as claimed in claim 19, the mobile barrage being anchored to preexisting lock walls.

21. The method as claimed in claim 14, wherein the level of the waterway upstream of the mobile barrage is detected, and the pumping power is adjusted in real time according to at least the detected level.
